(19) United States
(12) Patent Application Publication
(10) Pub. No.: US 2023/0038901 A1
(43) Pub. Date: Feb. 9, 2023

(54) ABSORBENT TISSUE PAPER PRODUCT, METHOD AND APPARATUS FOR PRODUCING THE SAME

(71) Applicant: Essity Hygiene and Health Aktiebolag, Göteborg (SE)

(72) Inventors: Gilles CATTACIN, Kunheim (FR); Marie BERTIN, Kunheim (FR)

(73) Assignee: Essity Hygiene and Health Aktiebolag, Göteborg (SE)

(21) Appl. No.: 17/783,422

(22) PCT Filed: Dec. 19, 2019
(86) PCT No.: PCT/EP2019/086400

§ 371 Date: Jun. 8, 2022

(51) Int. Cl. D21H 27/00; B31F 1/07; B31F 1/00; D21H 27/02

(52) U.S. Cl. CPC D21H 27/007; B31F 1/07; B31F 1/0019; D21H 27/02; B31F 2201/0733; B31F 2201/0756

(57) ABSTRACT

The present disclosure relates to an absorbent tissue paper product comprising one ply being an essentially continuous ply of fibrous structure having a first side and a second side, the first side having a surface roughness arithmetical mean height (Sa1), and said second side having a surface roughness arithmetical mean height (Sa2). Said ply has a micro-embossed structure and a difference between the surface roughness arithmetical mean heights of the first side and the second side is 7 μm or less (|Sa1−Sa2|≤7 μm), and said ply having a bulk of at least 7.5 cm3/g. The disclosure also relates to a method and an apparatus for producing such an absorbent tissue paper product.

### TECHNICAL FIELD

The present disclosure relates to an absorbent tissue paper product comprising one ply being an essentially continuous ply of a fibrous structure. The disclosure also relates to a method and an apparatus for producing such an absorbent tissue paper product.

### BACKGROUND

Paper tissue webs can be produced in several ways. Conventional paper machines have been used for many years for that purpose, to produce such conventional webs at a relatively low cost.

An example of a conventional paper tissue web process is the conventional dry crepe process which involves creping on a drying cylinder, the so-called yankee cylinder, by means of a crepe doctor. Wet creping can be used as well, if there are lower demands on the tissue quality. The creped, finally dry raw tissue paper, the so-called base tissue, is then available for further processing into the paper product for a tissue paper product.

Recently, more advanced methods have been developed, such as e.g. Through Air Drying (TAD), Advanced Tissue Molding System (ATMOS) and similar methods for producing structured tissue webs. A common feature for these latter methods is that they result in a more structured web with a lower density than a web produced on a conventional paper machine.

TAD technology has been developed since the 1960's and is well known to a person skilled in the art. It generally involves developing functional properties of the tissue by moulding the fibre mat on a structured fabric. This results in the fibre mat forming a structured tissue which may acquire high bulk and absorption due to air passing through the web while drying the web when still on the structured fabric.

ATMOS technology is a production method developed by Voith and which is also well known to a person skilled in the art.

A structured tissue web, such as e.g. a TAD produced tissue web or an ATMOS produced tissue web typically has one rough side (Hood side) and a smooth and soft side (Yankee side). This is also the case for conventional tissue but at a lower grade.

Especially on conventional paper tissue web, a common way to increase the thickness and lower the density, is to subject the web to embossing.

Embossing is to change the shape of a sheet from flat to shaped, so that there are areas that are raised and/or recessed from the rest of the surface, usually without rupturing the material. It therefore constitutes a deformation of the previously flat sheet, and results in a ply having a particular relief. The thickness of the ply or of the multiple plies is increased after embossing compared with its initial thickness.

Embossing may be performed by different methods, for example Rubber to Steel embossing (RS), Matched Steel embossing (MS) or Accurate Bulk Embossing (ABE).

During embossing, the web is normally passed between two rollers where at least one roll has a number of projections protruding from its surface. The other roll may also be provided with projections, such as with corresponding dents to the projections of the first roll, or with a resilient surface, depending on the embossing technique used.

As the web passes between the rolls, in some embossing techniques like Rubber to Steel (RS), the rolls form a nip by applying a pressure on the web. By adapting the pressure, a number of physical properties, such as caliper, softness, absorbency, physical integrity, resistance to linting etc. can be altered. In such adaptation, the design of the protruding elements is also taken into account.

In the case of matched steel embossing (MS) or Accurate Bulk Embossing (ABE), a small gap is formed between the rollers, rather than a nip. The gap may be adjusted to generate the level of caliper required. By adapting this gap, a number of physical properties, such as caliper, softness, absorbency, physical integrity, resistance to linting etc. can be altered.

As a result of embossing, the web will become deformed and its thickness will be increased. Embossing techniques are well known in the art and many variations of projections and dents can be used, as well as their number per surface unit, resulting in different number per surface unit of embossed dots on the embossed web.

By embossing, a pattern can be applied to a tissue paper fulfilling a decorative and/or functional purpose. When the embossing is made using more than 30 projections/dents per cm², resulting in more than 30 embossed dots per cm² on the web, this is often referred to as micro-embossing.

In order to decrease the thickness (caliper) and increase the softness of a web, it is well-known to use a method called calendering, where a web is passed between two rolls that are substantially smooth. Often one roll is a smooth steel roll and the other roll is also a smooth steel roll, or a smooth roll of resilient material, such as e.g. rubber.

In the field of paper tissue products, in particular products like hand towels, handkerchiefs, toilet paper, household paper and the like, there is a continuous need for improvement as regards providing products fulfilling their purpose of e.g. wiping or cleaning, having a soft and pleasant surface being pleasing to the user, and being economically and environmentally advantageous in view of raw material consumption, need for additives, and/or complex manufacturing processes.

As regards the need for a product having a soft and pleasant surface, it is also desired by users that the two sides of the surface shall be similar, i.e. that both sides of the product displays the same soft and pleasant surface. This property is referred to herein as “two-sidedness”, where high two-sidedness indicates that a user perceives a big difference between the feeling of the two sides of a paper tissue product, and low two-sidedness indicates that the user does not perceive any or very little difference between the feeling of the two sides of a paper tissue product. Low two-sidedness is what is desired herein, and is understood to give the user a perception of good quality in a tissue.

Since paper web forming technologies as those exemplified in the above often result in webs whose two surfaces (Yankee side and Hood side) are different, this need is usually met by forming multi-ply products comprising at least two webs, where the outermost webs are positioned with the same side (usually the Yankee side) facing outwards. Usually, the side of the webs having the greater perceived softness (the Yankee side) is positioned facing outwards.

### SUMMARY

A tissue paper product fulfilling one or more of the above-mentioned needs is provided by a tissue paper product according to claim 1. In a second aspect, this is provided by a method according to claim 14, and in a third aspect by an apparatus according to claim 25.

In particular, the present disclosure relates to paper tissue products, and methods and apparatuses for production of such paper tissue products, being disposable paper tissue products such as hand towels, handkerchiefs, toilet paper, household paper and the like.

In the present disclosure, a paper tissue product is proposed which may in particular consist of one single ply, and yet provide a satisfactory feel, being perceived as good quality by a user. As such, both sides of the paper tissue product as proposed herein may be adapted to display the same soft and pleasant surface to a user.

In a first aspect, the present disclosure relates to an absorbent tissue paper product comprising one ply being an essentially continuous ply of fibrous structure having a first side and a second side, said first side having a surface roughness arithmetical mean height Sa1, and said second side having a surface roughness arithmetical mean height Sa2. Said ply has a micro-embossed structure and a difference between the surface roughness arithmetical mean heights of the first side and the second side is 7 μm or less (|Sa1−Sa2|≤7 μm) and said ply has a bulk of at least 7.5 cm³/g.

Any differences between properties of the first and the second ply as referred to in this application, are defined as the absolute value of the differences. Accordingly, which side is denoted the first side and which side is denoted the second side of the ply is irrelevant for the disclosure.

The absorbent tissue paper product hence comprises a ply which combines a relatively similar surface roughness arithmetical mean height of the two sides with a bulk being satisfactory for an absorbent tissue paper product. In particular, the absorbent tissue product gives a perception of high quality to a user.

The ply has a micro-embossed structure, which structure provides for said relatively similar surface roughness arithmetical mean heights of the two sides of the ply.

In particular, because of the low two-sidedness and the satisfactory bulk of the ply, the absorbent tissue paper product may be formed by such a single ply only, which provides for a facilitated manufacturing process as compared to multi-ply products.

Optionally, said first side has a developed interfacial area ratio Sdr1 and said second side has a developed interfacial area ratio Sdr2, and a difference between the developed interfacial area ratios of the first side and the second side is 2% or less (|Sdr1−Sdr2|≤2%).

Optionally, said ply has a basis weight within the range of 18 to 60 gsm, preferably within the range of 25 to 40 gsm.

Optionally, said ply has a thickness within the range of 0.1 to 0.5 mm, preferably within the range of 0.2 to 0.35 mm.

Optionally, said ply has a CD wet strength within the range of 40 to 120 N/m, preferably within the range of 50 to 80 N/m.

Optionally, said ply has an absorption capacity of at least 7 g/g, preferably at least 9 g/g.

Optionally, said ply has a micro-embossed structure with at least 30 dots/cm².

Optionally, said ply has a micro-embossed structure with from 30 to 80 dots/cm², preferably from 40 to 60 dots/cm².

Optionally, said micro-embossed structure is an Accurate Bulk Embossing (ABE) structure.

Optionally, said micro-embossed structure is a Matched Steel embossing structure.

Optionally, said ply is a structured tissue paper ply. A structured tissue paper ply is a ply produced by a process which delivers a base sheet (ply) which is softer and more absorbent than what is possible with conventional technology. Examples of a structured tissue paper ply are a TAD technology produced ply or an ATMOS technology produced ply.

Optionally, said ply a TAD technology produced ply. I.e. the ply is produced by TAD technology.

Optionally, said ply is an ATMOS® technology produced ply. I.e. the ply is produced by ATMOS technology.

Optionally and most preferred, said absorbent tissue paper product consists of said ply. Because of the above-mentioned properties indicating that the ply has two sides with relatively similar feel and yet a sufficient bulk, the single ply is well adapted to form an absorbent tissue product without needing additional plies. In this case, the first and second sides of the ply, as mentioned in the above, constitute the first and second sides of the absorbent tissue paper product, said first and second sides being the outermost sides of the absorbent tissue product.

In a second aspect, there is provided a method for producing an absorbent tissue paper product comprising the steps of
providing one essentially continuous ply of fibrous structure having a first side and a second side, and
processing said ply such that said first side obtains a final surface roughness arithmetical mean height Sa1, and said second side obtains a final surface roughness arithmetical mean height Sa2, wherein a difference between the final surface roughness arithmetical mean heights of the first side and the second side is 7 μm or less (|Sa1−Sa2|≤7 μm) and said ply obtains a final bulk of at least 7.5 cm³/g.

Further, said step of processing said ply comprises the step of
micro-embossing said ply.

As mentioned in the introduction, micro-embossing is generally defined as micro-embossing with at least 30 dots/cm².

Optionally, said step of micro-embossing said ply comprises micro-embossing with from 30 to 80 dots/cm², preferably from 40 to 60 dots/cm².

Optionally, said step of micro-embossing said ply is performed by Accurate Bulk Embossing (ABE).

Optionally, said step of micro-embossed said ply is performed by Matched Steel embossing.

Optionally, said step of processing said ply comprises the step of:
Calendering said ply subsequent to said step of micro-embossing said ply.

The calendering may be steel-to-steel calendering or steel-to-rubber calendering.

Optionally, said step of micro-embossing said ply is performed such that that said first side obtains an intermediary surface roughness arithmetical mean height inSa1, and said second side obtains an intermediary surface roughness arithmetical mean height inSa2, and

said step of calendering said ply is performed such that that said first side obtains said final surface roughness arithmetical mean height Sa1, and said second side obtains said final surface roughness arithmetical mean height Sa2, wherein a difference between the intermediary surface roughness arithmetical mean heights is less than or equal to said difference between the final surface roughness arithmetical mean heights.

The micro-embossing may be made to reduce the two-sidedness of the ply. However, the micro-embossed ply may still not be good enough from an handfeel point of view, which it why it may be desired to calender the ply after micro-embossing.

When calendering is performed after micro-embossing, the calendering step may however increase the difference between the surface roughness arithmetical mean heights of the first and second side, i.e. the calendering step may increase the difference between the two sides of the ply. Accordingly, to achieve the desired absorbent paper tissue product, the micro-embossing may be performed to arrive at a difference between the intermediary surface roughness arithmetical mean heights of the first and second side being less than the desired difference between the first and second sides of the final ply.

Optionally, said step of micro-embossing said ply is performed such that said first side obtains an intermediary developed interfacial area ratio inSdr1 and said second side obtains an intermediary developed interfacial area ratio inSdr2, and said subsequent step of calendering said ply is performed such that said first side obtains a final developed interfacial area ratio Sdr1 and said second side obtains a final developed interfacial area ratio Sdr2, and wherein a difference between the intermediary developed interfacial area ratios is less than or equal to a difference between said final developed interfacial area ratios.

Optionally, said step of processing said ply comprises processing said ply such that said first side obtains a final developed interfacial area ratio Sdr1 and said second side obtains a final developed interfacial area ratio Sdr2, and a difference between the developed interfacial area ratios of the first side and the second side is 2% or less (|Sdr1−Sdr2|≤2%).

Optionally, said step of providing an essentially continuous ply of fibrous structure comprises providing a ply which is produced by structured tissue technology, preferably TAD technology or alternatively by ATMOS technology. Generally, said step of providing a ply may comprise providing a ply which displays a relatively high two-sidedness.

Optionally, said method comprises a step of converting said ply to a product consisting of said ply. To this end, the method may comprise forming rolls or stacks, perforating, or cutting said ply into finished products.

Optionally, said method comprises forming a product incorporating any of the options as laid out in the above in relation to the product. In particular, the step of processing said ply may be performed so as to obtain a ply having any of the properties, alone or in combination, as set out for the ply in the above description of the absorbent tissue paper product.

In addition to the above, the product/method may comprise additional embossing patterns/forming additional embossing patterns, such as decorative embossings, with or without colour print.

Embossing patterns provided in the ply in addition to the micro-embossed structure may impact the surface roughness of the ply.

For determining the surface roughness parameters as set out in the above, measurements should be made on areas of the ply being free from any such additional embossing patterns, such that the measurements reflect the surface roughness parameters of areas of the ply having said micro-embossed structure.

It is generally not desired that embossing patterns other than the micro-embossed structure should significantly impact the overall perceived softness of the ply. Accordingly, it is proposed that any such additional embossing patterns should take up less than 15%, preferably less than 10%, most preferred less than 5% of the total surface area of the ply. Alternatively, the ply may be free from such additional embossing patterns.

The micro-embossed structure may advantageously be applied over the total surface of the ply, apart from at the locations of any additional embossing patterns. Hence, the micro-embossed structure may advantageously extend over more than 85%, preferably more than 90%, most preferred more than 95% of the total surface area of the ply. Alternatively, the micro-embossed structure may extend over substantially the entire area of the ply.

In a third aspect, the present disclosure relates to an apparatus for performing the method as set out in the above, said apparatus comprising an embossing station and a calendering station.

Optionally, the embossing station may be a Matched Steel (MS) embossing station.

Optionally, the embossing station may be a Accurate Bulk Embossing (ABE) station.

Optionally, said embossing station and said calendering station are mutually adapted to each other so as to perform a method as described in the above.

Optionally, the apparatus further comprises a product forming station for forming said ply into product. Such a product forming station may comprise a cutting station, a perforation station, a folding station and/or a rolling station etc.

Further definitions, options and advantages of the products and methods as disclosed herein are disclosed in the following description.

### BRIEF DESCRIPTION OF THE DRAWINGS

Below follows a more detailed description of an example product, method and apparatus with reference to the appended drawings, wherein:

FIG. 1 is schematic view of a variant of a product as disclosed herein;

FIG. 2 is a flow chart of a variant of a method as disclosed herein;

FIG. 3 is a schematic view of a variant of an apparatus as disclosed herein.

### DETAILED DESCRIPTION

Throughout this application, the parameters used are defined as follows:

Sa:

Sa is the extension of Ra (arithmetical mean height of a line) to a surface. It expresses, as an absolute value, the difference in height of each point compared to the arithmetical mean of the surface. This parameter is used generally to evaluate surface roughness.

Sdr:

Sdr (Developed interfacial area ratio)

The Sdr parameter is the ratio between the area of the “real” developed surface and the area of the “projected” surface.

The Sdr of a completely planar surface is 0.

Sa and Sdr are defined by ISO25178 using a non-contact type method.

Basis weight: Basis weight is determined in accordance with ISO 12625-6:2016.

Thickness: Thickness is determined in accordance with ISO 12625-3.

Bulk: Bulk is determined by the ratio thickness/basis weight.

CD wet strength: CD wet strength is measured in accordance with ISO 12625-5.

Absorption capacity: Absorption capacity was measured according to ISO12625-8:2011.

Panel Softness:

Panel softness is determined by evaluation made by panel members. The panelists rank products in terms of softness (handfeel). The Softness Panel values are therefore comparative values enabling a comparison between the samples tested, rather than an absolute parameter. The softer the product/tissue base sheet is rated the higher the value will be.

Each sample is composed of one product, i.e. a multi-ply tissue paper product. The dimensions of the samples are therefore the dimensions of the finished products. Samples are conditioned for minimum 2 hours in a controlled area at 23° C. and 50% relative humidity.

The different samples are comfort rated by ten panelists, and an average comfort rating for each product is determined over the panelists. Samples are placed in MD in front of the panelists. Hence, softness panel values are comparative values within a test and indicate the perceived softness of a product.

For the purpose of this application, softness panel values given in one and the same table are comparable and indicate the perceived relative softness of the products tested. The higher the value of the rating, the more comfortable is the product.

With the absorbent tissue paper products of the present disclosure, an absorbent paper tissue product is proposed which may preferably consist of one single ply, and yet allow both sides of the product to display the same soft and pleasant surface to a user.

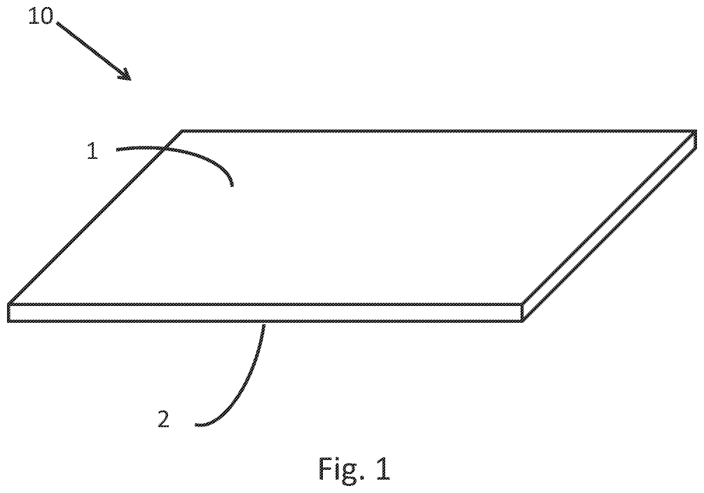

FIG. 1 illustrate schematically a variant of an absorbent tissue paper product, which absorbent tissue paper product consists of one single ply 10, said ply being an essentially continuous ply of fibrous structure. The ply 10 has a first side 1 and a second side 2, said first side 1 having a surface roughness arithmetical mean height Sa1, and said second side 2 having a surface roughness arithmetical mean height Sa2.

Further, a difference between the surface roughness arithmetical mean heights of the first side 1 and the second side 2 is 7 μm or less (|Sa1−Sa2|≤7 μm) and the bulk of said ply is from 7.5 cm³/g.

Optionally, the absorbent paper tissue product presents any of the features as set out in the summary section of the application, alone or in combination.

For example, advantageously said first side 1 of the ply 10 may have a developed interfacial area ratio (Sdr1) and said second side 2 of the ply 10 may have a developed interfacial area ratio (Sdr2), and a difference between the developed interfacial area ratios of the first side and the second side is 2% or less (|Sdr1−Sdr2|≤2%).

Moreover, the ply 10 may advantageously present a basis weight within the range of 18 to 60 gsm, a thickness within the range of 0.1 to 0.5 mm, a CD wet strength within the range of 40 to 120 N/m, and/or an absorption capacity of more than 7 g/g.

Optionally, and preferably, the ply (10) may have a micro-embossed structure with from 30 to 80 dots/cm².

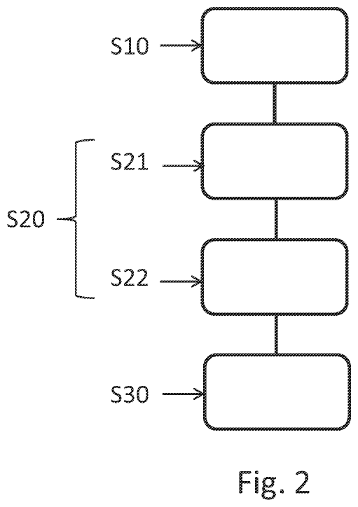

FIG. 2 illustrate schematically a method as proposed herein, which may be used to provide a product e.g. as exemplified in FIG. 1.

As such, the method is a method for producing an absorbent tissue paper product comprising the steps of
S10: providing one essentially continuous ply of fibrous structure having a first side and a second side, and
S20: Processing said ply such that said first side obtains a surface roughness arithmetical mean height Sa1, and said second side obtains a surface roughness arithmetical mean height Sa2, wherein a difference between the surface roughness arithmetical mean heights of the first side and the second side is 7 μm or less (|Sa1−Sa2|≤7 μm) and the bulk of said ply is at least 7.5 cm³/g.

According to an example variant, the ply which is initially provided and to be processed as set out in the above, is a structured tissue paper produced by a TAD paper machine. The TAD paper making process is well known and results in a structured paper tissue web having a relatively low density, but also two distinct different sides, a Hood side that is relatively rough, and a Yankee side that is relatively smooth and soft. Hence, TAD ply provided in the first step of the method has a relatively high two-sidedness, and would generally not fulfil the requirements as set out in the above for the desired tissue paper product, especially as regards softness to touch.

In another example variant, the base ply is instead a structured tissue paper produced by a ATMOS paper machine. Also this type of structure tissue paper generally has a relatively high two-sidedness.

In addition, said step S20 of processing said ply comprises a step S21 of micro-embossing said ply.

By micro-embossed is as set out in the above meant an embossing where the embossing rolls provides the ply with at least 30 embossing dots per cm². For example, from 30 to 80 dots/cm², or preferably from 40 to 60 dots/cm² may be used.

Optionally, the micro-embossing may be performed by MS embossing or ABE embossing. By adjusting the gap between the rolls in these embossing techniques in relation to the thickness of the structured paper tissue ply, a surprisingly effective reduction of the two-sidedness between the first and the second side may be achieved. In other words, the embossing pattern and the embossing gap may be adjusted so as to reduce the difference between the surface roughness arithmetical mean heights of the first side and the second side, for the specific base ply in question.

In some cases, the micro-embossing alone is sufficient to process the base ply so as to arrive at the desired difference between the final surface roughness arithmetical mean heights of the two plies, and the desired bulk.

However, even if the ply after micro-embossing might display a satisfactory two-sidedness, it may still provide a rough hand-feel to a user.

Optionally, the method comprises a calendering step S22 performed after said micro-embossing step S21. The calendering step S22 may be used to achieve the final desired thickness of the ply and to improve the softness. The calendering may take place between two smooth metal rolls, or alternatively between one metal roll and one rubber roll.

The micro-embossing step will in general increase the thickness of the ply, and reduce the two-sidedness. The calendering step will in contrast decrease the thickness of the ply, and improve softness perception.

Purely as an example, a variant of the method as proposed herein for producing a variant of the product as proposed herein will be described in the following. Reference is made to Table 1 in the below.

TABLE 1

| | Basis | | | | | | |
|---|---|---|---|---|---|---|---|
| | weight | Thickness | Bulk | \|Sa1-Sa2\| | \|Sdr1-Sdr2\| | Panel | Absorption |
| | g/m² | mm/ply | cm3/g | μm | % | — | g/m² |
| Base sheet | 25.8 | 0.41 | 15.9 | 15.0 | 6.3 | 1.4 | 294 |
| Calendered base sheet | 25.0 | 0.36 | 14.4 | 0.6 | 1.3 | 1.6 | 277 |
| Micro-emboss (ABE) | 26.1 | 0.57 | 21.9 | 1.8 | 3.7 | 1.2 | 326 |
| Micro-emboss (ABE + | 25.4 | 0.39 | 15.4 | 5.9 | 2.3 | 2.4 | 302 |
| calendering) | | | | | | | |

In the examples, the absorbent tissue paper products produced and evaluated comprised one single ply only. The properties of the single plies set out in Table 1 are therefore also the properties of the corresponding absorbent tissue paper products.

In a first example, the starting point is a ply (the base sheet) being TAD ply having a thickness of 0.41 mm, and a difference between the surface roughness arithmetical mean heights of the first side and the second side being about 15 μm. When evaluated by a softness panel, the panel softness rating for the ply was 1.4, a value which in this case indicated a non-satisfactory softness for an absorbent tissue product.(see line 1 in Table 1)

In a second example, the same base sheet is calendered. This results in the difference between the surface roughness arithmetical mean heights of the first side and the second side going down to only 0.6 μm. However, the panel softness rating of the calendred base sheet increases only slightly as compared to the uncalendered base sheet, to 1.6 (see line 2 in Table 1).

In a third example, the same initial base sheet is micro-embossed by ABE. This results in the difference between the surface roughness arithmetical mean heights of the first side and the second side becoming 1.8 μm. The panel softness rating of the micro-embossed base sheet decreases slightly when compared to the base sheet, to a rating of 1.2 (see line 3 in Table 1)

In a fourth example, the same initial base sheet is first micro-embossed (as in line 3 of Table 1), then calendared. The difference between the surface roughness arithmetical mean heights of the first side and the second side increases when compared to the ply being only micro-embossed, said difference being 5.9 μm. Still, the difference is within the range of 7 μm or less as proposed in this application, indicating a satisfactory low two-sidedness. Notably, the panel softness rating of the micro-embossed and calendared base sheet increases to 2.4, which in this case indicates that a satisfactory softness for an absorbent tissue product is achieved (see line 4 in Table 1).

In view of the above examples, it is seen how a reduction of the two-sidedness of the ply by means of micro-embossing enables achieving products having advantageous properties especially when it comes to softness. In particular, it enables production of an absorbent tissue paper product comprising one ply, which ply is micro-embossed and calendered, and which ply displays a low two-sidedness as proposed herein. Since such a ply may (as demonstrated by the above examples) display advantageous softness to touch in combination with said low two-sidedness, meaning that such a ply is particularly suitable for forming an absorbent tissue paper product consisting of such a ply only.

In view of the above example, it is understood that a person skilled in the art may elaborate using the micro-embossing step and the calendering step so as to achieve a product as proposed herein and with various other features as desired.

For example, optionally said step S21 of micro-embossing said ply is performed such that that said first side obtains an intermediary surface roughness arithmetical mean height inSa1, and said second side obtains an intermediary surface roughness arithmetical mean height inSa2, and said step S22 of calendering said ply is performed such that that said first side obtains said final surface roughness arithmetical mean height Sa1, and said second side obtains said final surface roughness arithmetical mean height Sa2, wherein a difference between the intermediary surface roughness arithmetical mean heights (|inSa1−inSa2|) is less than or equal to in said difference between the final surface roughness arithmetical mean heights (|Sa1−Sa2|). In other words, although the calendaring step may increase the two-sidedness, as compared to a ply being micro-embossed only, the person skilled in the art may adapt the production method so as to still achieve a final product falling within the ranges proposed herein.

The reasoning in the above regarding difference between the surface roughness arithmetical mean height values of the first and second side of the ply is similarly applicable to the intermediary and final difference between the developed interfacial area ratios of the first and second ply, which final difference is preferably 2% or less (|Sdr1−Sdr2|≤2%).

The step S20 of processing said ply may further comprise processing the ply so as to obtain any of the features of the product as set out in the summary section of the application.

Further, the method may comprise a step S30 of converting said ply 10 to a product, preferably a step of forming said ply to a product consisting of said ply 10. This step may involve e.g. cutting, perforating, folding or rolling said ply 10.

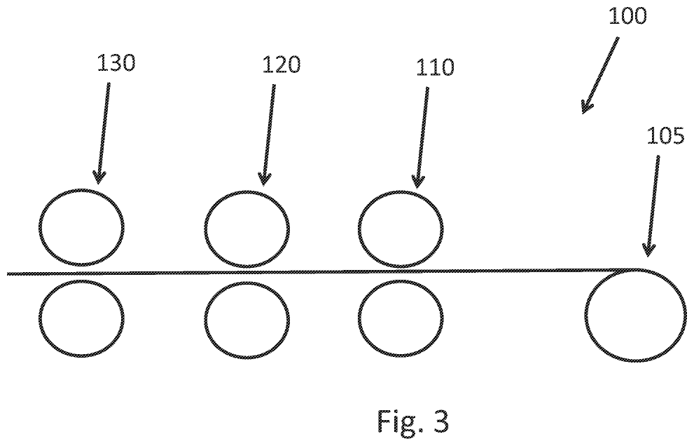

FIG. 3 schematically illustrates an apparatus for performing a method as disclosed herein/producing a product as disclosed herein, said apparatus 100 comprising an embossing station 110 and a calendering station 120.

The embossing station 110 and/or the calendering station 120 may optionally be adapted to perform any of the steps of the method as described in this application.

Optionally, the apparatus may comprise a forming station 130 for forming said ply into final products. To this end, the forming station 130 may comprise one or more stations such as cutting, perforating folding or rolling stations.

Numerous variants and options of the product, method and apparatus as disclosed herein will be conceivable by the person skilled in the art.

For example, the product may comprise embossings in addition to the micro-embossing, such embossings may be made together with colour print.

1. An absorbent tissue paper product comprising one ply being an essentially continuous ply of a fibrous structure having a first side and a second side, said first side having a surface roughness arithmetical mean height (Sa1), and said second side having a surface roughness arithmetical mean height (Sa2), said ply being a structured tissue paper ply,
wherein
said ply has a micro-embossed structure and
a difference between the surface roughness arithmetical mean heights of the first side and the second side is 7 μm or less (|Sa1−Sa2|≤7 μm), and in that said ply has a bulk of at least 7.5 cm³/g.

2. An absorbent tissue paper product according to claim 1, wherein said first side has a developed interfacial area ratio (Sdr1) and said second side has a developed interfacial area ratio (Sdr2), and a difference between the developed interfacial area ratios of the first side and the second side is 2% or less (|Sdr1−Sdr2|≤2%).

3. An absorbent tissue paper product according to claim 1, wherein said ply has a basis weight in the range of 18 to 60 gsm.

4. An absorbent tissue paper product according to claim 1, wherein said ply has a thickness in the range of 0.1 to 0.5 mm.

5. An absorbent tissue paper product according to claim 1, wherein said ply has a CD wet strength in the range of 40 to 120 N/m.

6. An absorbent tissue paper product according to claim 1, wherein said ply has an absorption capacity of at least 7 g/g, preferably at least 9 g/g.

7. An absorbent tissue paper product according to claim 1, wherein said micro-embossed structure comprises from 30 to 80 dots/cm².

8. An absorbent tissue paper product according to claim 7, wherein said micro-embossed structure is an Accurate Bulk Embossed (ABE) structure.

9. An absorbent tissue paper product according to claim 7, wherein said micro-embossed structure is a Matched Steel embossed structure.

10. (canceled)

11. An absorbent tissue paper product according to claim 1, wherein said ply is a TAD technology produced ply.

12. An absorbent tissue paper product according to claim 1, wherein said ply is an ATMOS® technology produced ply.

13. An absorbent tissue paper product according to claim 1 consisting of said ply.

14. Method for producing an absorbent tissue paper product comprising the steps of;
providing one essentially continuous ply of a fibrous structure having a first side and a second side, said ply being a structured tissue paper ply, and
processing said ply such that said first side obtains a final surface roughness arithmetical mean height (Sa1), and said second side obtains a final surface roughness arithmetical mean height (Sa2), wherein
a difference between the final surface roughness arithmetical mean heights of the first side and the second side is 7 μm or less (|Sa1−Sa2|≤7 μm) and said ply obtains a final bulk of at least 7.5 cm³/g, and
said step of processing said ply comprises a step of
micro-embossing said ply, and a step of
calendering said ply subsequent to said step of micro-embossing said ply.

15. Method according to claim 14, wherein said step (S21) of micro-embossing said ply comprises micro-embossing with from 30 to 80 dots/cm².

16. Method according to claim 14, wherein said step (S21) of micro-embossing said ply is performed by Accurate Bulk Embossing (ABE).

17. Method according to claim 14, wherein said step (S21) of micro-embossing said ply is performed by Matched Steel embossing.

18. (canceled)

19. Method according to claim 14,
wherein said step of micro-embossing said ply is performed such that that said first side obtains an intermediary surface roughness arithmetical mean height (inSa1), and said second side obtains an intermediary surface roughness arithmetical mean height (inSa2), and
said step of calendering said ply is performed such that that said first side obtains said final surface roughness arithmetical mean height (Sa1), and said second side obtains said final surface roughness arithmetical mean height (Sa2),
wherein a difference between the intermediary surface roughness arithmetical mean heights (|inSa1−inSa2|) is less than or equal to said difference between the final surface roughness arithmetical mean heights (|Sa1−Sa2|).

20. Method according to claim 14, wherein said step of micro-embossing said ply is performed such that said first side obtains an intermediary developed interfacial area ratio (inSdr1) and said second side obtains an intermediary developed interfacial area ratio (inSdr2), and
said subsequent step of calendering said ply is performed such that said first side obtains a final developed interfacial area ratio (Sdr1) and said second side obtains a final developed interfacial area ratio (Sdr2), and wherein a difference between said intermediary developed interfacial area ratios (|inSdr1−inSdr2)| is less than or equal to a difference between said final developed interfacial area ratios (|Sdr1−Sdr2)|).

21. Method according to claim 14, wherein said step of processing said ply comprises processing said ply such that said first side obtains a final developed interfacial area ratio (Sdr1) and said second side obtains a final developed interfacial area ratio (Sdr2), and a difference between the final developed interfacial area ratios of the first side and the second side is 2% or less (|Sdr1−Sdr2|≤2%).

22. Method according to claim 14 wherein said step of providing a ply comprises providing a ply which is a structured tissue ply, preferably which is produced by TAD technology or alternatively a ply which is produced by ATMOS technology.

23. Method according to claim 14, comprising a step of converting said ply to a product consisting of said ply.

24. Method according to claim 14 comprising producing
an absorbent tissue paper product comprising one ply being an essentially continuous ply of a fibrous structure having a first side and a second side, said first side having a surface roughness arithmetical mean height (Sa1), and said second side having a surface roughness arithmetical mean height (Sa2), said ply-being a structured tissue paper ply,
wherein
said ply has a micro-embossed structure and
a difference between the surface roughness arithmetical mean heights of the first side and the second side is 7 μm or less (|Sa1−Sa2|≤7 μm), and in that said ply has a bulk of at least 7.5 cm³/g.

25. Apparatus for performing the method according to claim 14, said apparatus comprising an embossing station and a calendering station.
